(19) United States
(12) Patent Application Publication
(10) Pub. No.: US 2025/0310588 A1
(43) Pub. Date: Oct. 2, 2025

(54) METHODS AND SYSTEMS FOR CONTENT SYNCHRONIZATION

(71) Applicant: Comcast Cable Communications, LLC, Philadelphia, PA (US)

(72) Inventors: Matthew EBERSVILLER, Evergreen, CO (US); Ryan MCMURRAY, Arvada, CO (US); Jonathan KIRKOVICH, Parker, CO (US)

(21) Appl. No.: 18/623,730

(22) Filed: Apr. 1, 2024

(51) Int. Cl. H04N 21/41; H04N 21/214; H04N 21/43; H04N 21/433; H04N 21/438

(52) U.S. Cl. CPC H04N 21/4104; H04N 21/2143; H04N 21/43076; H04N 21/4331; H04N 21/438

(57) ABSTRACT

Methods and systems are described for synchronizing output of a content item between user devices. A first user device associated with a network device may broadcast a message to discover nearby devices that can provide access to a content item. A second user device may respond with information to access the content at the second user device. The second user device may send synchronization information to allow the first user device and the second user device to output the content item at least partially in sync. The first user device may use the information in the response to access the content from the second user device and output the content to a user.

### BACKGROUND

In conventional video streaming, each user device accessing content may independently download, decodes, and displays a separate video stream. In some instances, users in different locations (e.g., different rooms, domicile, premises, neighborhoods, or the like) may want to watch the same video content in a synchronized manner such that they can enjoy or discuss the content in real time with other viewers. Further, with more than one video machine independently downloading and decoding content, network bandwidth may be utilized inefficiently, which may affect the display of content to the video player machine. Thus, there is a need for more sophisticated techniques for content delivery.

### SUMMARY

Systems, methods, and apparatuses are described for delivery of a content item. A first device may receive an indication to request content, such as a show, movie, live stream, or other media. The first device may retrieve the content from a server and begin playback of the content. A second device may receive an indication (e.g., from a user) to output the content. Instead of accessing the content from the sever, the second device may access the content from the first device. The second device may send a message (e.g., broadcast message) indicating that second device is attempting to locate the content. The message may be sent on a local area network and/or forwarded to other networks, such as networks nearby (e.g., a network for a neighborhood, a network for multiple neighborhoods). If the first device receives the message, the first device may analyze the message and determine that the first device is storing and/or outputting the content that the second device is attempting to locate. The first device may send a response to the second device. The response may include at least a portion of the content, data to access the content from the first device, and/or synchronization information. The second device may use information in the response to access the content from the first device and output the content. The synchronization information may be used to synchronize output of the content between the first device and the second device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 shows an example system.

FIG. 2A shows an example system.

FIG. 2B shows an example system.

FIG. 2C shows an example system.

FIG. 3 shows an example method.

FIG. 4 shows an example method.

FIG. 5 shows an example method.

FIG. 6 is a block diagram illustrating an example computing device.

### DETAILED DESCRIPTION OF ILLUSTRATIVE EMBODIMENTS

Systems, methods, and apparatuses are described for accessing content and/or synchronizing the output of a content item. A network device may be determined to be a “lead” (e.g., or edge) device to neighboring network devices for purposes of content delivery. Neighboring devices may access the lead network device via a local area network, neighborhood network, multi-neighborhood network, group of local area networks, regional network, and/or the like. The lead device may refer to any computing device (e.g., network device, edge device, user device) that stores at least a portion of a content item for one or more other network devices. The lead device may be a user device that is accessing the content item from a server. The lead device may be in a local area network at a user premises. Other computing devices at the user premises, at neighboring premises, in the same neighborhood, and/or group of neighborhoods may access the content item from the lead device instead of the server.

The lead device may be outputting the content item for a user. The lead device may determine a video and audio location associated with the content item indicative of the current playback position within the content item at the lead device. The video and/or audio location may comprise presentation time stamp (PTS), fragment byte range/boundary, or the like. The lead device may detect messages (e.g., broadcast message) from other nearby devices inquiring as to which local devices have a least a portion of the content item. The lead device may send responses to these messages. The responses may comprise at least a portion of the content item, information to access the content item, synchronization information, and/or the like. The synchronization information may comprise the determined video and/or audio location, playback speed, current time, time offset information, and/or the like. The synchronization information may allow neighboring devices to decode the content item and output the content item at least partially in synch (e.g., within a threshold that is not noticeable to users) with the lead device.

In some scenarios, the lead device may send out one or more broadcast messages announcing that the lead device has content available to access. Computing devices receiving the broadcast messages may store information from the broadcasted messages, such as a network address of the lead device. The computing devices may use the stored information if a user requests the content item. The computing devices may send a message to the lead device to access the content and/or any updated synchronization information.

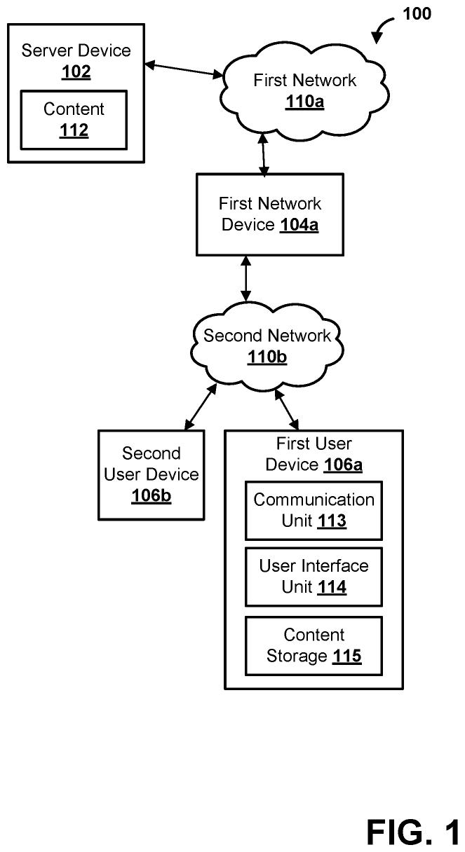

FIG. 1 shows a block diagram of an example system 100. The system 100 may comprise a server device 102 (e.g., content server, edge device, application server). The system 100 may be capable of facilitating communications among devices or provisioning of content among devices. The system 100 may comprise a first network device 104 (e.g., gateway device, a termination system, a cable modem termination system, a network node, switch, router, or combination thereof). The system may comprise one or more user devices 106a,b such as a first user device 106a and a second user device 106b.

It should be noted that while the singular term device is used herein, it is contemplated that some devices may be implemented as a single device or a plurality of devices (e.g., via load balancing). The server device 102, the first network device 104, the one or more user devices 106a,b may each be implemented as one or more computing devices. Any device disclosed herein may be implemented using one or more computing nodes, such as virtual machines, executed on a single device and/or multiple devices.

The server device 102, the first network device 104a, and the user device(s) 106a,b may be communicatively coupled via one or more networks 110a,b such as a first network 110a (e.g., a wide area network), and a second network 110b (e.g., a local area network). The first network 110a may comprise a content distribution and/or access network. The first network 110a may facilitate communication via one or more communication protocols. The first network 110a may comprise fiber, cable, or any a combination thereof. The first network 110a may comprise wired links, wireless links, any combination thereof, and/or the like. The first network 110a may comprise routers, switches, nodes, gateways, servers, modems, and/or the like. The second network 110b may be a local area network associated with one or more devices (e.g., user device 106a,b).

The server device 102 may be configured to provide one or more services, such as account services, application services, network services, content services, or a combination thereof. The server device 102 may comprise services for one or more applications on the user device 106a,b. The server device 102 may generate application data associated with the one or more application services. The application data may comprise data for a user interface, data to update a user interface, data for an application session associated with the user device 106, and/or the like. The server device 102 may comprise content 112. The content 112 may comprise media content (e.g., video content, audio content, text content, metadata, or a combination thereof). The content 112 may be organized as content channels (e.g., or streams, files) that provide users to view content items as linear content (e.g., which may be streamed, accessed, tuned to, downloaded, and/or the like). The server device 102 may be configured to receive requests for content from user devices, such as the first user device 106a and the second user device 106b.

The first network device 104a may comprise a computing device, a gateway device, an access point (e.g., wireless access point), a router, a modem, device controller (e.g., automation controller, security controller, premises health controller, content device controller), a switch, network node, a combination thereof, and/or the like. The first network device 104a may be configured to communicate using the one or more networks (e.g., network 110a,b). The first network device 104a may be configured to implement one or more services associated with the services device 102, such as a content service, a premises service, a voice controlled service, an automation service, a security service, a health monitoring service, or a combination thereof.

The one or more user devices 106a,b may (e.g., may each) may comprise an electronic device including hardware, software, embedded logic components, or a combination of two or more such components and capable of carrying out the appropriate functionalities implemented or supported by the device 106a,b. As an example and not by way of limitation, the one or more user devices 106a,b may be each be computing device, such as a smart device (e.g., smart glasses, smart watch, smart phone), a desktop computer, a notebook or laptop computer, netbook, tablet, handheld electronic device, mobile device, a computing station, a laptop, a digital streaming device, a set-top box, a streaming stick, a television, other suitable electronic device, or any suitable combination thereof. In some scenarios, a user may have multiple user devices, such as a mobile phone, a smart watch, smart glasses, a combination thereof, and/or the like. The one or more user devices 106a,b may enable a user (e.g., or multiple users) to access a network (e.g., network 110a,b). The one or more user devices 106a,b may be configured to enable user(s) to communicate with other users at another device associated with one or more networks (e.g., network 110a,b), such as other user devices (e.g., user devices 106a,b), the first network device 104, the server device 102, and/or the like, via a communication unit 113.

The one or more user device 106 may be configured to output a user interface 114. The user interface may be output via the user interface 114 via an application, service, and/or the like, such as a content browser. The user interface 114 may receive application data and/or content (e.g., content 112) from the server device 102. The application data may be processed by the user device 106 to cause display of the user interface 114. The user interface 114 may be displayed on a respective display of the one or more user device 106a,b. The display may comprise a television, screen, monitor, projector, and/or the like. The user interface 114 may comprise a premises management application, a premises automation application, a content management application (e.g., for accessing video, audio, gaming, and/or other media), a smart assistant application, a virtual assistant application, a premises security application, network services application, or a combination thereof. The user interface 114 may be configured to allow a user to configure settings associated with the local network device, such as the second network device 104b. The one or more user device 106 may be configured to store content (e.g., content 112 received from the server device 102) via a content storage 115. The content storage 115 may comprise any type of suitable memory, such as RAM, ROM, a hard disk, a subscriber identity module (SIM) card, a memory stick, a secure digital (SD) memory card, and/or any other suitable non-removable or removable memory configured to store content (e.g., content 112) associated with a server device 102. Though not shown, it should be understood that each user device may comprise a corresponding communication unit 113, user interface unit 114, and content storage 115. Although FIG. 1 illustrates a particular arrangement of the one or more user devices 106a,b, the one or more networks 110a,b, the server device 102, and the first network device 104, among other things, this disclosure contemplates any suitable arrangement. In some scenarios, some of the devices of the system 100 may be physically or logically combined with each other in whole or in part.

The first user device 106a may be configured to store and/or cause output of a content item (e.g., content 112). The output of a content item may be caused by the first user device 106a based on a user request received via a second user device 106b. The content item may be accessed from the server device 102 and stored at least partially on the first user device 106a, via content storage 115 (e.g., during output of the content item). The first user device 106a may be configured to progressively download, from the server device 102, segments of the content item as output of the content item via first user device 106a progresses. The first user device 106a may be configured to send content in the content storage 115 to other devices, such as the second user device 106. The first user device 106a may also send other information to allow synchronization of output of the content between devices accessing the content.

The second user device 106b may be configured to send a broadcast message. The broadcast message may be associated with discovering nearby devices (e.g., the first user device 106a) currently outputting a content item (e.g., content 112) and/or storing the content item (e.g., content storage 115). The broadcast message may be sent based on (e.g., in response to) a request from a user, received by the second user device 106b, to access the content item. The second user device 106b sending the broadcast message may be configured to use the first user device 106a as an edge cache to access content sections (e.g., content segments) currently downloaded to the first user device 106a. The broadcast message may be broadcast to one or more devices (e.g., the first user device 106a) associated with a local area network (e.g., second network 110b). The broadcast message may be broadcast via the first network device 104a. The first network device 104 may be configured to connect (e.g., communicatively couple via one or more network links) one or more devices (e.g., user device 106) to a wider area network (e.g., first network 110a). The broadcast message may be broadcast via a local area network (e.g., second network 110b). The first network device 104a may send the broadcast message to any of the devices connected to the second network 110b. The broadcast message may comprise one or more of a transmission control protocol message, a layer two message, data link layer, or an ethernet message.

The first user device 106a may receive the broadcast message. The first user device 106a may be configured to analyze data in the broadcast message. The data in the broadcast message may comprise an indication of content (e.g., a specific show, movie, episode) the second user device 106b is attempting to access. The indication of content may comprise an identifier, a name (e.g., content title), a uniform resource locator (e.g., a link for accessing the content on the server device 102). The first user device 106a may compare the indication of the content to information (e.g., metadata, identifier, name, title) associated with content stored in the content storage 115. If the requested content matches the stored content, the first user device 106a may be configured to generate and/or send a response message to the second user device 106b. The response message may comprise content, such as one or more content segments of the content matching the request that is stored in the content storage 115. The response message may comprise information to access (e.g., download) the content from the content storage 115, such as a manifest, one or more uniform resource locators, resource name, folder name, network address, media access control address, internet protocol address, and/or the like.

The response message may comprise synchronization information. The synchronization may comprise information to configure the second user device 106b to output the content substantially at the same time (e.g., with a threshold amount) as the first user device 106a. The synchronization information may comprise one or more of a byte range, a time stamp, a segment identifier, or a frame identifier indicative of a currently outputted portion of the content item (e.g., content 112). The synchronization information may comprise an indication of one or more of: a byte location in a data chunk of the content item, or a reference frame for decoding a frame at the byte location. The first user device 106a may be configured to send the response message to the second user device 106b.

The synchronization information associated with the first user device 106a may, for example, comprise one or more frame locations, such as a frame location associated with an I-Frame, a frame location associated with a B-Frame, a combination thereof, and/or the like. A frame location may be the synchronization point between the first user device 106a and the second user device 106b. The synchronization point may be defined as a particular position, point, frame, or any other suitable metric in the content by the first user device 106a that the second user device 106b may be configured to synchronize with. The synchronization information may comprise an I-Frame associated with the video of the first user device 106a to enable the second user device 106b to decode a B-Frame associated with the video. An I-Frame may be a picture of video data encoded independently without reference to any other picture or frame associated with the video data. I-Frames may be used as random access points to which the decoder may navigate in the bitstream and decode the video. An example B-Frame may comprise intra macroblocks and inter macroblocks with motion vectors referenced to other pictures associated with the video data. B-frames may reference previous frames in decoding order. Some reference frames may be future references (e.g., followed in display order). If the frame location requires other frames to decode the frame at the frame location, then the synchronization information may comprise multiple frames. For example, the synchronization information associated with the first user device 106a may comprise a I-Frame at frame location 980 and a B-Frame at frame location 1,000. The B-Frame at frame location 1,000 may be the synchronization point between the first user device 106a and the second user device 106b. The synchronization information may only comprise an I-Frame associated with the first user device 106a, in examples where the synchronization point may be an I-Frame associated with the video received by first user device 106a. In such instances, the I-Frame may not be dependent on another frame to be decoded, therefore device 106a would only communicate the I-Frame location, via the synchronization information.

In some scenarios, the first user device 106a may send multiple response messages. The first user device 106a may only have a portion of the content, such as several segments of the content. If the first user device 106a downloads an additional portion of the content, such as a subsequent set of segments, then the first user device 106a may send additional response messages comprising one or more of the additional portion of the content, information for accessing the additional portion of the content, and/or the like. If the first user device 106a experiences a change in playback (e.g., due to network changes, or user instructions, such as fast forward, rewind, pause), then the first user device 106a may send an additional response message (e.g., an additional response to the original broadcast message) with updated synchronization information. The second user device 106b may adjust playback based on the updated synchronization information.

The second user device 106b may be configured to receive the response message (e.g., or multiple response messages) to the broadcast message. The response message may comprise the synchronization information. The second user device 106b may be configured to access the content. If the response message comprises the content, the second user device 106b may be configured to cause output of the content. If the response message does not comprise the content, then the second user device 106b may access the content from the first user device 106a using the information to access the content in the response message. The output of content item by the second user device 106b may be at least partially synchronized with output of the content item (e.g., content 112) by the first user device 106a based on the synchronization information. The second user device 106b may start output of the content at a section of the content based on the synchronization information. If the synchronization information does not account for an offset (e.g., delay due to network traversal and device processing), the second user device 106b may add an offset (e.g., to a position indicated in the synchronization information), if there is an expected delay, between output of content by the first user device 106a and the output of content of the second user device 106b. In some scenarios, the first user device 106a may introduce delay to allow the second user device 106b to catch up to the playback position of the first user device 106a.

If the second user device 106b does not receive a response message, the second user device 106b may be configured to access the content item (e.g., content 112) from the server device 102. The second user device 106b may store the content item 112 in content storage on the second user device 106b. The second user device 106b may store the content item 112 at least temporarily for output of the content item (e.g., to a user via user interface 114). The second user device 106b may be configured to progressively download from the first user device 106a (e.g., or the server device 102), segments (e.g., or sections, portions, blocks) of the content item (e.g., content 112) as output of the content item via the second user device 106b progresses.

In some scenarios, the first user device 106a may be configured to send a broadcast message. The first user device 106a may be configured to send a broadcast message associated with notifying nearby devices that the first user device 106a is storing (e.g., and/or accessing) the content item (e.g., content 112). The phrase nearby devices is not intended to convey that the device must be within a specific distance, but only to indicate that the user device is attempting to find a device that is closer than the server device 102. The broadcast message may be broadcast to the second user device 106b. The broadcast message may be broadcast via a network device (e.g., network device 104) that connects the one or more user devices 106 to a local area network and/or wider area network. The network device may comprise a network switch. The broadcast message may be broadcast via a local area network (e.g., second network 110b). The broadcast message may comprise one or more of a transmission control protocol message, a layer two message, data link layer, or an ethernet message. This broadcast message may comprise the same or similar information as the response message described above, such as the synchronization information, a portion of the content, and/or information to access the content item.

The first user device 106a may be configured to receive a request for the content item (e.g., content 112) from any devices receiving the broadcast. The request may be based upon (e.g., triggered by) receiving the broadcast and/or receiving a user request to access the content item. For example, the second user device 106b may store information in the broadcast message until a user requests the content item. The user request may trigger the second user device 106b to check for the information from the broadcast before trying other approaches, such as sending a broadcast to find a local device outputting the content and/or sending a request to the server device 102. The second user device 106b may be configured to use the first user device 106a as an edge cache to access the segments currently downloaded to the first user device 106a.

If the broadcast message from the first user device 106a does not include synchronization information, content, and/or the like, the request from second user device 106b may comprise a request for the synchronization information, content, information to access the content, and/or the like. The first user device 106a may be configured to send at least a portion of the content item (e.g., content 112) and the synchronization information that allows the second user device 106b to at least partially synchronize output of the content item associated with the second user device 106b with output of the content item by first user device 106a.

In some scenarios, the second user device 106b may first reach out to the server device 102 to access the content item. The server device 102 may be configured to track which user devices already have at least a portion of the content item. The server device 102 may determine the user device that has at least a portion of the content item that is closest to the second user device 106b. For example, the server device 102 may determine that the first user device 106a is the closest user device with the portion of the content item. The server device 102 may send a response to the second user device 106b instructing the second user device 106b to access the content item from the first user device 106a. The second user device 106b may communicate with the first user device 106a to receive at least a portion of the content item, the synchronization information, and/or other information.

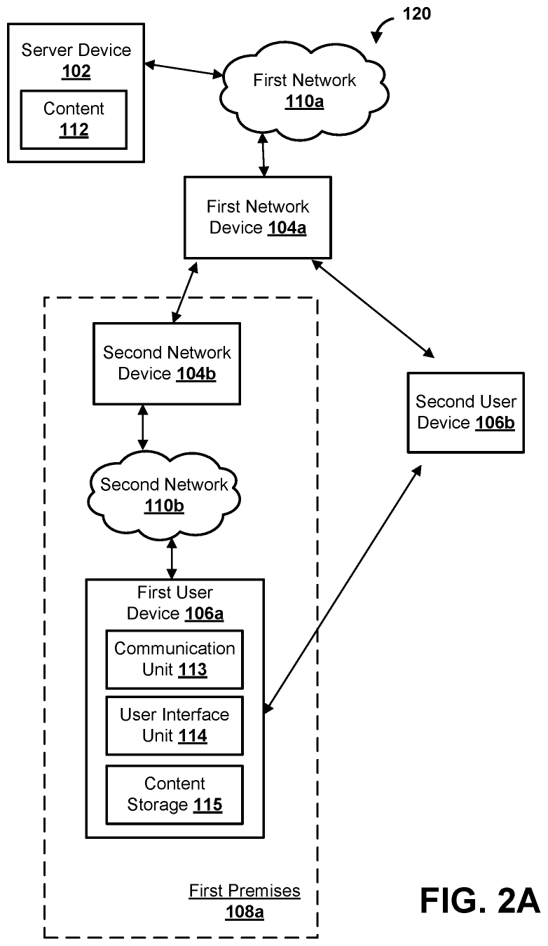

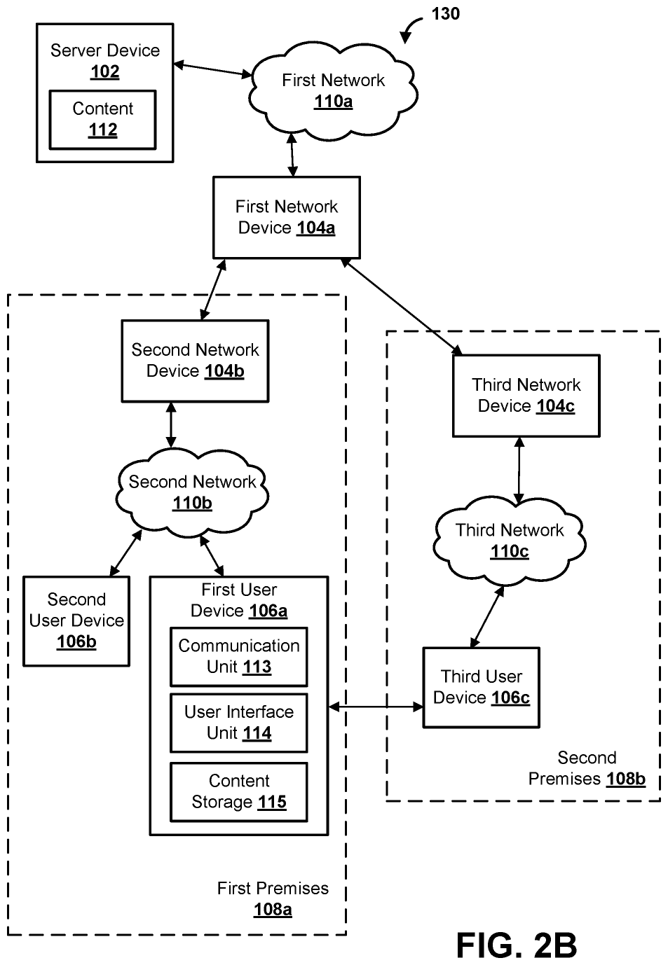

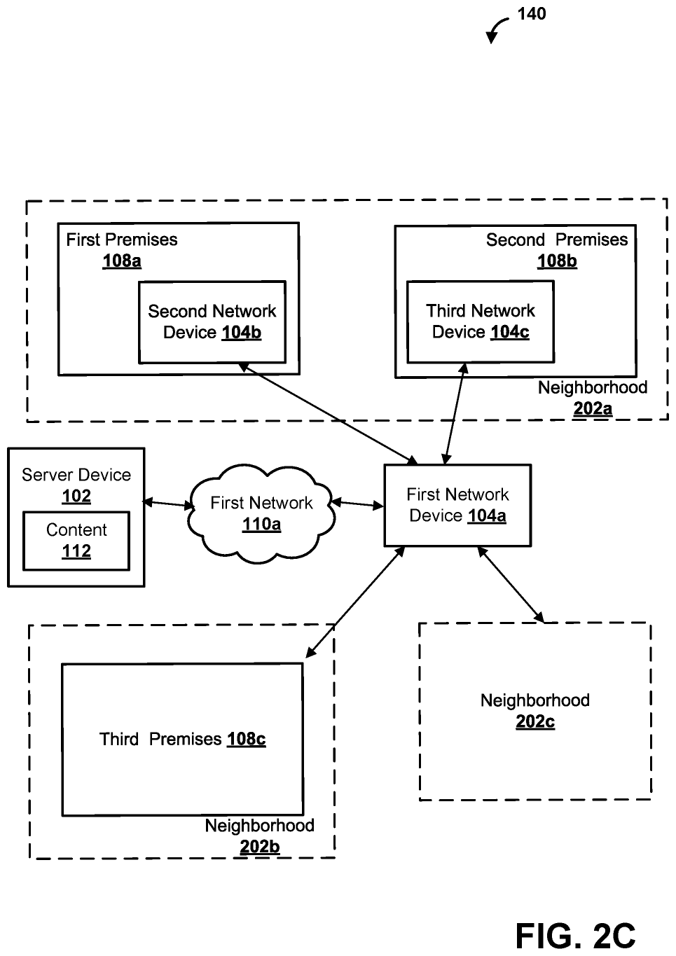

In a scenario in which the first user device 106a and second user device 106b are associated with (e.g., located at) a home, domicile, subnet, building (e.g., first premises 108a of FIG. 2A), the server device 102 may determine the user device that has a portion of the content item that is closest to the second user device 106b via IP address assigned to a gateway or modem at which each of the user devices may be associated. In a scenario in which the second user device 106b is located outside a premises of the first user device 106a, or in separate premises, the server device 102 may utilize each of the IP addresses associated with each of the one or more devices to determine the user device that has a portion of the content item that is closest to the second user device 106b. In this scenario, the IP addresses of each of the one or more devices may be associated with a larger subnet (e.g., first network 110a) which may contain all premises within a particular area, which may define a neighborhood (e.g., first neighborhood 202a of FIG. 2C).

FIG. 2A shows a block diagram of an example system 120. The system 120 may comprise any of the devices and/or features of FIG. 1, such as the server device 102, one or more network devices 104a,b, and one or more networks 110a,b. The system 120 may comprise one or more network devices 104a,b, such as the first network device 104a, and the second network device 104b. The system 120 may comprise one or more user devices 106a,b, such as the first user device 106a, and the second user device 106b. The system 120 may comprise a first premises 108a.

The second network 110b may be a local area network at the first premises 108a. The first premises 108a may be customer premises. The first premises 108a may include an area within a coverage range (e.g., wireless range) of the corresponding network device, such as the second network device 104b. The first premises 108a may comprise a property, dwelling, terminal, building, floor, and/or the like. The first premises 108a may comprise different rooms, walls, door, windows, and/or the like. The one or more user devices (e.g., first user device 106a) may move within the premises which they are located at and/or move outside of the premises. The first user device 106a may be located at the first premises 108a. The second user device 106b may be located external to the first premises 108a.

The first user device 106a and/or the second user device 106b may perform any of the features and/or operations described elsewhere herein, such as in the description corresponding to FIG. 1. The second user device 106b may receive content (e.g., and other information, such as synchronization information) from the first user device 106a as described elsewhere herein. In some scenarios, the second user device 106b may be within range (e.g., wireless range, such as at a neighboring premises) of the first user device 106a. The second user device 106b may send the broadcast message wirelessly. To accomplish the wireless broadcast, the second user device 106b may send Transmission Control Protocol (TCP) or User Datagram Protocol (UDP) packets to the first user device 106a over a network, local area network (LAN), Bluetooth, or any other suitable wireless communication protocol (e.g., a protocol that supports TCP/IP). The first user device 106a may receive, based on the wireless transmission, the broadcast message directly from the second user device 106b. A wireless connection may be formed (e.g., in response to, based on the broadcast message) between the first user device 106a and the second user device 106b. The wireless connection may be used to send the content (e.g., and synchronization information) to the second user device 106b.

In other scenarios, the second user device 106b may send the broadcast message via the first network device 104a, which may be external to the first premises 108a. The first network device 104a may be configured to broadcast the broadcast message to any devices to which the first network device 104a is connected. A second network device 104b located at the first premises 108a (e.g., and communicatively coupled to the first network device 104) may receive the broadcast message from the first network device 110a. The second network device 104b may analyze the broadcast message and determine (e.g., based on the analysis) to broadcast (e.g., or otherwise send) the broadcast message to any devices on the second network 110b, such as the first user device 106a. The second network device 104b may send the broadcast message to the second network 110b. The first user device 106a may receive the broadcast message from the second network device 104b. The first user device 106a may send a response to the broadcast message, as described elsewhere herein, such as by sending content, information to access the content, and/or synchronization information. The response may be sent to the second user device 106b via the second network device 104b and the first network device 104a. The second user device 106b may use the information in the response to access the content item from the first user device 106a, output the content (e.g., either in sync using the synchronization information, or not in synch), and/or the like.

FIG. 2B shows a block diagram of an example system 130. The system 130 may comprise any of the devices and/or features of FIG. 1, such as the server device 102, one or more network devices 104a,b,c, and one or more networks 110a,b,c. The system 130 may comprise one or more network devices 104a,b,c, such as the first network device 104a, the second network device 104b, and a third network device 104c. The system 130 may comprise one or more user devices 106a,b,c such as the first user device 106a, the second user device 106b, and a third user device 106c. The system 130 may comprise a first premises 108a and a second premises 108b. The first user device 106a and the second user device 106b may be located at the first premises 108. The third user device 106c may be located at the second premises 108b.

The first user device 106a, the second user device 106b, and/or the third user device 106c may perform any of the features and/or operations described elsewhere herein, such as in the description corresponding to FIG. 1. The second user device 106b and/or third user device 106c may receive content (e.g., and other information, such as synchronization information) from the first user device 106a and output the content as described elsewhere herein.

The second user device 106b may communicate with the first user device 106a via the second network 110b to exchange broadcast messages, responses, content, synchronization information and other information. For example, the second user device 106b may send a broadcast message to the second network 110b. The second user device 106b may send the broadcast message via TCP/IP protocol, IP multicast, IP unicast over a local area network (e.g., second network 110b), and/or the like. The first user device 106a may receive the broadcast message. The first user device 106a may analyze the broadcast message and determine that the content indicated in the broadcast message is being stored and/or output via the first user device 106a. The first user device 106a may send a response message as described elsewhere herein, such as by sending content, information to access the content, and/or synchronization information. The response may be sent to the second user device 106b via the second network device 104b. The second user device 106b may use the information in the response to access the content item from the first user device 106a, output the content (e.g., either in sync using the synchronization information, or not in synch), and/or the like.

In some scenarios, the third user device 106c may be within range (e.g., wireless range, such as at a neighboring premises) of the first user device 106a. The third user device 106c may communicate wirelessly with the first user device 106a to exchange broadcast messages, responses, content, synchronization information and other information (e.g., such in the manner described for the second user device 106b of FIG. 2A). The third user device 106 may use the information received from the first user device 106a to access the content item from the first user device 106a, output the content (e.g., either in sync using the synchronization information, or not in synch), and/or the like.

In other scenarios, the third user device 106c may send the broadcast message via the third network device 104c which may be located at the second premises 108c. The third network device 104c may be configured to broadcast the broadcast message to any devices to which the third network device 104c is connected (e.g., via a network link), such as any devices located at the second premises 108b. The third network device 104c may be configured to broadcast (e.g., or otherwise send) the broadcast message to a network device external to the second premises 108b, such as the first network device 104a. The first network device 104a may be configured to broadcast (e.g., or otherwise send) the broadcast message to one or more other premises to which the first network device 104a is connected, such as to the first premises 108a. The first network device 104a may use any process to select which devices to send the broadcast message. The first network device 104a may send the broadcast message to all devices on a particular subnet, all devices (e.g., downstream from the server device 102) that have a network connection the first network device 104a, a portion of devices connected to the first network device 104a that are closest to the original sender, or any combination thereof. The first network device 104a may have a port configuration that allows a determine of which devices are closest and/or most likely to have content. The first network device 104a may have a cache or other memory that stores an indication of any devices already receiving the content. The cache may be used to determine which devices to send the broadcast message to (e.g., the devices that are already receiving the content). The first network device 104a may be configured to broadcast (e.g., or otherwise send) the broadcast message to the second network device 104b.

One or more devices of the system (e.g., the first user device 106a, the second user device 106b, the third user device 106c, the first network device 104a, the second network device 106b, the third network device 104c, or the server device 102) may be configured to perform a selection process to determine an optimal location to obtain content (e.g., if multiple locations are available). For example, the selection process may comprise a latency measurement (e.g., taking into consideration number of network device hops and network congestion being factors in latency calculation). One or more latency measurements of corresponding paths to locations of the content may be compared to select the fastest option. A first latency measurement may be taken measuring latency from the third user device 106c (e.g., or second user device 106b) to the server device 102. A second latency measurement may be taken measuring latency from the third user device 106c (e.g., or second user device 106b) to the first user device 106a. The first latency measurement and the second latency measurement may be compared to determine which path is faster for a particular user device to retrieve content. In some scenarios, a content provider static configuration could be in force instructing neighboring devices negating the need for a latency measurement. For example, an apartment complex could be put under a configuration by a content provider to ensure content arrives to every device in apartment complex at the same time. The static configuration could be a configuration of one or more devices located a premises (e.g., the first user device 106a, the second user device 106b, the third user device 106c, the second network device 104, the third network device). The static configuration may be a configuration of one or more devices located external to a user premises (e.g., the first network device 104a, the server 102).

The second network device 104b located at the first premises 108a (e.g., and communicatively coupled to the first network device 104) may receive the broadcast message from the first network device 104a. The second network device 104b may analyze the broadcast message and determine (e.g., based on the analysis) to broadcast (e.g., or otherwise send) the broadcast message to any devices on the second network 110b, such as the first user device 106a and the second user device 106b. The first user device 106a may receive the broadcast message from the second network device 104b. The first user device 106a may send a response to the broadcast message, as described elsewhere herein, such as by sending content, information to access the content, and/or synchronization information. The response may be sent to the third user device 106c via the second network device 104b, the first network device 104a, and the third network device 106c. The third user device 106c may continue to communicate via the second network device 104b, the first network device 104a, and the third network device 106c to send content to the third user device 106c (e.g., while the users are still accessing and/or outputting the content, or predicted to consume the content). The third user device 106c may use the information in the response to access the content item from the first user device 106a, output the content (e.g., either in sync using the synchronization information, or not in synch), and/or the like.

FIG. 2C shows a block diagram of an example system 140. The system 140 may comprise any of the devices and/or features of FIG. 1, such as the server device 102, one or more network devices 104a,b,c, one or more user devices, and one or more networks 110. The system 140 may comprise one or more network devices 104a,b,c, such as a first network device 104a, a second network device 104b, a third network device 104c, and a fourth network device 104d. Although not illustrated in FIG. 2C, it is contemplated that system 140 may further comprise one or more user devices (e.g., user device 106a of FIG. 1) associated with each of the one or more network devices (e.g., second network device 104b, third network device 104c, fourth network device 104d). The system 140 may comprise a first premises 108a, a second premises 108b, and a third premises 108c. It is contemplated that there may be any number of premises in the system 140. The system 140 may comprise one or more neighborhoods 202a,b,c.

One or more neighborhoods (e.g., a first neighborhood 202a, a second neighborhood 202b, a third neighborhood 202c) may further comprise at least one premises (e.g., premise 108a,b,c). The neighborhoods illustrated in FIG. 2C may comprise any number of network devices, user devices, networks, and/or the like, or any combination thereof, similar to system 120 and system 130 of FIG. 2A and FIG. 2B. It is further contemplated that each network device may be associated with one or more local networks (e.g., network 110b,c of FIG. 2B) associated with one or more premises 108a,b,c. A first neighborhood 202a may comprise one or more premises, such as first premises 108a and a second premises 108b. A second neighborhood 202b may comprise a third premises 108c. A third neighborhood 202c may comprise other premises (not shown). Each of the one or more neighborhoods 202a,b,c may comprise one or more of a property, dwelling, terminal, building, floor, and/or the like, or any combination thereof.

A user device at the first premises 108a may be configured to send a message to search for a location to access content requested by a user. The message may be associated with discovering nearby devices (e.g., one or more user devices associated with a neighborhood or premises, or any user device not broadcasting the message) outputting a content item and/or storing the content item. The user device and/or other devices in the system 140, such as the network device 104a,b,c may follow a successive process in which messages (e.g., broadcast messages) are sent first to the local area network, and each time no response is received, messages may be sent to the next broadest network area. For example, if no response is received from sending a broadcast message at the premises, then additional message may be broadcast (e.g., or otherwise sent) to other premises in the first neighborhood 202a. If no response is received, the message may be broadcast (e.g., or otherwise sent) from the first neighborhood 202a to other neighborhoods, such as the second neighborhood 202b and/or the third neighborhood 202c. If another device responds with content, information to access content, and/or synchronization information, then then user device sending the broadcast message may proceed to access the content from the responding device as described further herein. In some scenarios, such as if the responding device is in the same premises (e.g., or in the same neighborhood), the user device may use the synchronization information to synchronize output of the content with the responding device.

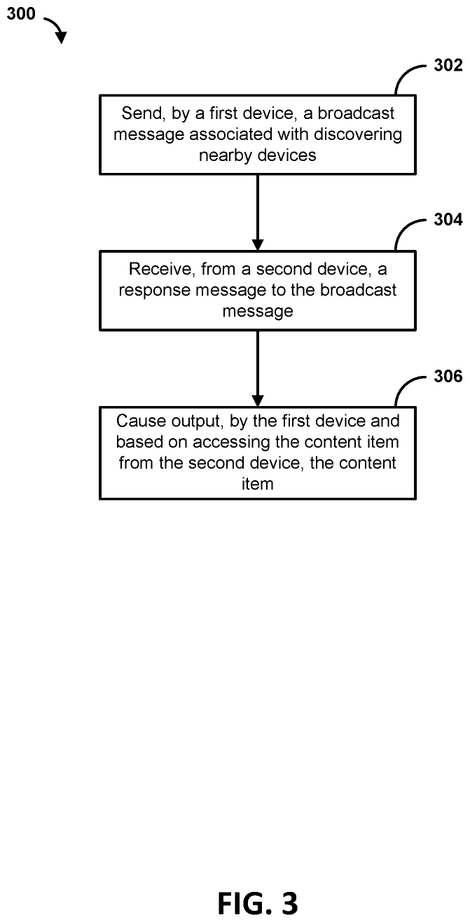

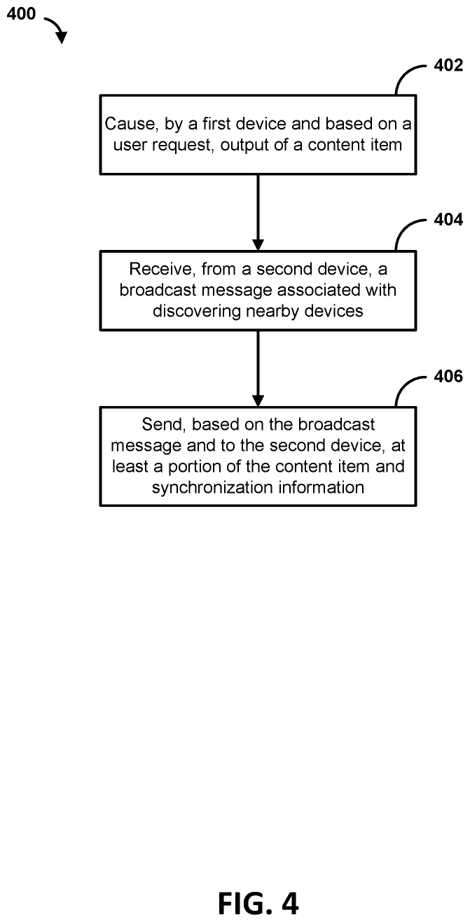

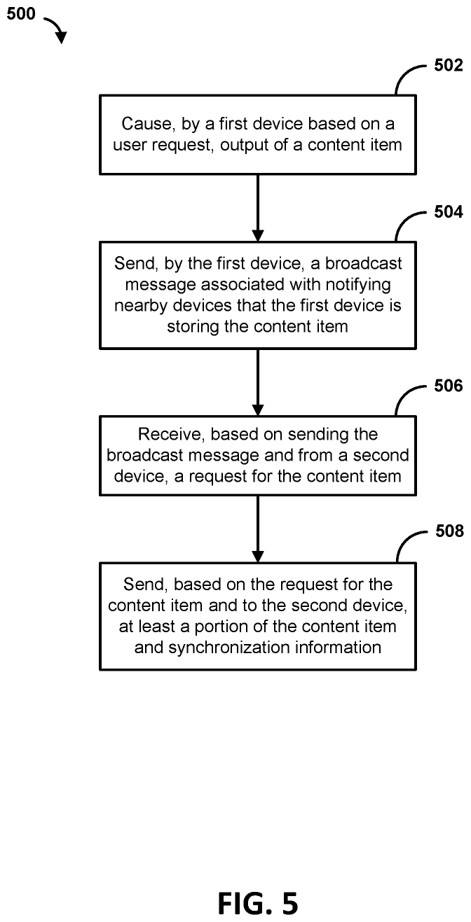

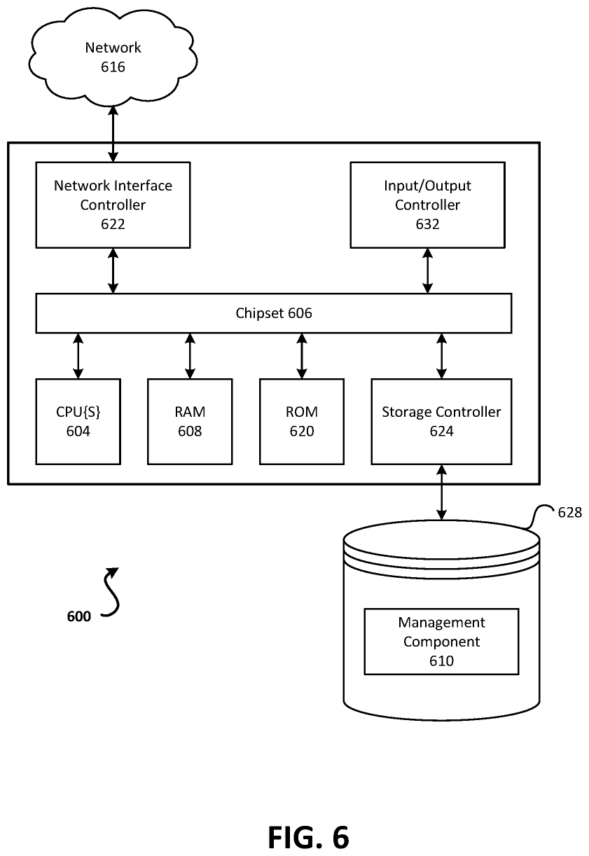

FIG. 3 shows an example method. The method 300 may comprise a computer implemented method for providing a service (e.g., a content service, a network service, a communication service, or a combination thereof). A system and/or computing environment, such as the system 100, system 120, system 130, and system 140 of FIG. 1, FIG. 2A, FIG. 2B, FIG. 2C and/or the computing environment of FIG. 6, may be configured to perform the method 300. The method 300 may be performed in connection with the system illustrated in FIG. 1 or the systems illustrated in FIG. 2A, FIG. 2B, or FIG. 2C. Any step or combination of steps of the method 300 may be performed by a computing device, network device, network node, and/or client device, such as any of the devices shown in FIG. 1, FIG. 2A, FIG. 2B, and/or FIG. 2C. Any of the features of the methods of FIGS. 4, and 5 may be combined with any of the features and/or steps of the method 300 of FIG. 3.

At step 302, a broadcast message associated with discovering nearby devices outputting (e.g., currently outputting and/or storing) the content item may be sent. The broadcast message associated with discovering nearby devices outputting the content item may be sent by a first device (e.g., one or more of user device 106a, user device 106b, or user device 106c). The broadcast message may be sent based on a request from a user associated with the first device to access a content item (e.g., content 112). The first device may be configured to use the second device (e.g., one or more of user device 106a, user device 106b, or user device 106c that did not broadcast the message) as an edge cache to access segments currently downloaded to the second device. The broadcast message may be broadcast to a plurality of devices in a premises (e.g., a property, dwelling, terminal, building, floor, and/or the like) and/or a neighborhood. The broadcast message may be broadcast via a network device (e.g., network device 104a,b,c,d) that connects a plurality of premises and/or neighborhoods to a wider area network.

A first user, associated with a first device (e.g., first user device 106a), and a second user, associated with a second device (e.g., second user device 106b,c) may both request to watch a football game (e.g., content 112), associated with a server device (e.g., server device 102). The second user may be watching the football game before the first user. The first user may request to access the football game at the time (e.g., same segment) as the second user is viewing via the second device. As a result, the first user, via the first user device, may broadcast a message associated with discovering nearby devices outputting the football game (e.g., the second device). The broadcast message may be determined and/or sent based on (e.g., in response to) a request from the first user to access a content item (e.g., the football game) via a server device (e.g., server device 102).

At step 304, a response message to the broadcast message may be received from a second device (e.g., second user device 106b,c). The second device may be configured to access a content item (e.g., content 112) from a server device (e.g., server 102) and store the content item at least temporarily for output of the content item. The second device may be configured to progressively download, from the server device, segments of the content item as output of the content item via the second device progresses. The response message may comprise synchronization information. Synchronization information may comprise one or more of a byte range, a time stamp, a segment identifier, or a frame identifier indicative of a currently outputted portion of the content item.

A first user associated with a first device (e.g., user device 106a) may receive a response message to the broadcast message sent via the first device. The response message may be sent from the second device (e.g., user device 106b,c). For example, the second device may be configured to access content (e.g., content 112) associated with a football game from a server device (e.g., server device 102). The second device may store the content item or portions thereof at least temporarily for output of the content (e.g., football game). The second device may be configured to progressively download, from a server (e.g., server device 102), segments of the football game as output of the content item via the second device progresses.

At step 306, output of the content item from the second device may be caused. The output the content item from the second device may be caused by the first device and based on accessing the content item from the second device. The output of content item by the first device may be at least partially synchronized with output of the content item by the second device based on synchronization information from the second device. Synchronization information may comprise one or more of a byte range, a time stamp, a segment identifier, or a frame identifier indicative of an outputted portion of the content item. The synchronization information may comprise an indication of one or more of: a byte location in a data chunk of the content item, or a reference frame for decoding a frame at the byte location.

The first device and the second device may be located at a same premises. In another scenario, the first premises may be located in a same neighborhood as a second premises. In some scenarios, the first premises may be located in a different neighborhood than the second premises.

The first device (e.g., first user device 106a), based on accessing a football game (e.g., content 112 or content item) from the second device (e.g., second user device 106b,c), may output the content item (e.g., the football game) from the second device. The output of the football game associated with the first device may be at least partially synchronized with output of the football game associated with the second device. The output may be at least partially synchronized based on the synchronization information associated with the second device received by the first device.

FIG. 4 shows an example method. The method 400 may comprise a computer implemented method for providing a service (e.g., a network service, a communication service). A system and/or computing environment, such as the system 100 of FIG. 1, system 120 of FIG. 2A, system 130 of FIG. 2B, system 200 of FIG. 2C and/or the computing environment of FIG. 6, may be configured to perform the method 400. The method 400 may be performed in connection with the system illustrated in FIG. 1. Any step or combination of steps of the method 400 may be performed by a computing device, network device, network node, and/or client device, such as any of the devices shown in FIG. 1, FIG. 2A, FIG. 2B, or FIG. 2C. Any of the features of the methods of FIGS. 3 and 5 may be combined with any of the features and/or steps of the method 400 of FIG. 4.

At step 402, output of a content item may be caused. The output of a content item may be caused by a first device (e.g., first user device 106a) and based on a user request. The content item may be accessed (e.g., received, downloaded) from a server device. The content item may be stored at least temporarily on the first device during output of the content item. The first device may be configured to progressively download, from the server device, segments of the content item as output of the content item via the first device progresses. The first device may comprise one or more of a set-top box, a digital streaming device, or a user device. The first device may receive the content from a server device. The first device may store the content item at least temporarily for output of the content item.

Output of a content item (e.g., a tv show) may be caused by the first device (e.g., first user device 106a) based on a user request. The tv show may be assessed (e.g., received, downloaded) from a server device (e.g., server device 102). The tv show may be stored at least temporarily on the first device during output of the content item. The first device may be configured to progressively download, from the server device, segments of the tv show as output of the content item via the first device progresses. The first device may receive the information associated with the tv show from a server device. The first device may store the tv show at least temporarily for output of the content item.

At step 404, a broadcast message associated with discovering nearby devices currently outputting the content item may be received. The broadcast message may be received from a second device. The first device may be located at a first premises. The second device is located at a second premises. The first device and the second device may be located at a same premises. The first premises may be located in a same neighborhood as the second premises. The first premises may be located in a different neighborhood than the second premises.

The second device may be configured to use the first device as an edge cache to access the segments currently downloaded to the second device. The second device may comprise one or more of a set-top box, a digital streaming device, or a user device. The broadcast message may be broadcast to a plurality of devices in a neighborhood. The broadcast message may be broadcast via a network device that connects a plurality of premises to a wider area network. The network device may comprise a network switch. The broadcast message may be broadcast via a local area network located at a premises. The broadcast message may comprise one or more of a transmission control protocol message, a layer two message, data link layer, or an ethernet message.

The second device (e.g., second user device 106b,c) may send a broadcast message associated with discovering nearby devices currently outputting the content item (e.g., tv show). The broadcast message may be received, via the first device (e.g., first user device 106a), from the second device. The first device may be located at a first premises (e.g., first premises 108a). The second device may be located at a second premises (e.g., premises 108b).

The second device (e.g., second user device 106b,c) may be configured to use the first device (e.g., first user device 106a) as an edge cache to access the segments associated with the content item (e.g., a tv show) currently downloaded to the first device. The second device may comprise one or more of a set-top box, a digital streaming device, or a user device. The broadcast message may be broadcast to a plurality of devices in a neighborhood (e.g., neighborhood 202a,b,c). The broadcast message may be broadcast via a network device (e.g., first network device 104a) that connects a plurality of premises (e.g., premises 108) or a plurality of neighborhoods to a wider area network. The network device may comprise a network switch. The broadcast message may be broadcast via a local area network (e.g., second network 110b, and/or third network 110c) located at a premises. The broadcast message may comprise one or more of a transmission control protocol message, a layer two message, data link layer, or an ethernet message.

At step 406, at least a portion of the content item and synchronization information may be sent. The synchronization information may allow the second device to at least partially synchronize output of the content item by the second device with output of the content item by the first device. The at least a portion of the content item and synchronization information may be sent based on the broadcast message. The at least a portion of the content item and synchronization information may be sent by the first device to the second device. The synchronization information may comprise one or more of a byte range, a time stamp, a segment identifier, or a frame identifier indicative of a currently outputted portion of the content item. The synchronization information may comprise an indication of one or more of: a byte location in a data chunk of the content item, or a reference frame for decoding a frame at the byte location.

The first device (e.g., first device 106a) may send at least a portion of the content item (e.g., a tv show) and synchronization information to the second device (e.g., second device 106b). The synchronization information may allow the second device to at least partially synchronize output of the tv show by the second device with output of the tv show by the first device. The at least a portion of the tv show and synchronization information may be sent based on the broadcast message. The at least a portion of the content item and synchronization information may be sent by the first device to the second device. The synchronization information may comprise one or more of a byte range, a time stamp, a segment identifier, or a frame identifier indicative of a currently outputted portion of the content item. The synchronization information may comprise an indication of one or more of: a byte location in a data chunk of the content item, or a reference frame for decoding a frame at the byte location.

FIG. 5 shows an example method. The method 500 may comprise a computer implemented method for providing a service (e.g., a network service, a communication service). A system and/or computing environment, such as the system 100 of FIG. 1, and/or the computing environment of FIG. 6, may be configured to perform the method 500. The method 500 may be performed in connection with the system illustrated in FIG. 1, FIG. 2A, FIG. 2b, and/or FIG. 2C. Any step or combination of steps of the method 500 may be performed by a computing device, network device, network node, and/or client device, such as any of the devices shown in FIG. 1. Any of the features of the methods of FIGS. 3 and 4 may be combined with any of the features and/or steps of the method 500 of FIG. 5.

At step 502, output of a content item may be caused. The output of the content item may be caused by a first device (e.g., first user device 106a). The output of the content item may be caused based on a user request. The content item may be accessed and/or received from a server device and stored at least partially on the first device (e.g., at least temporarily, such as during output of the content item). The first device may be configured to progressively download, from the server device, segments of the content item as output of the content item via the second device progresses. The first device may comprise one or more of a set-top box, a digital streaming device, or a user device.

At step 504, a broadcast message associated with notifying nearby devices that the first device is storing the content item may be sent. The broadcast message associated with notifying nearby devices that the first device is storing the content item may be sent by the first device. The broadcast message may be broadcast to a plurality of devices in a neighborhood (e.g., neighborhood 202a,b,c). The broadcast message may be broadcast via a network device (e.g., network device 104a) that connects a plurality of premises to a wider area network. The network device may comprise a network switch. The broadcast message may be broadcast via a local area network located at a premises. The broadcast message may comprise one or more of a transmission control protocol message, a layer two message, data link layer, or an ethernet message.

At step 506, a request for the content item may be received. The request for the content item may be received based on sending the broadcast message. The request for the content item may be received from a second device (e.g., user device 106b,c). The second device may be configured to use the first device as an edge cache to access the content segments currently downloaded to the first device. The second device may comprise one or more of a set-top box, a digital streaming device, or a user device. The first device may be located at a first premises. The second device may be located at a second premises. The first device and the second device may be located at a same premises. The first premises may be located in a same neighborhood as the second premises. The first premises may be located in a different neighborhood than the second premises.

At step 508, at least a portion of the content item may be sent. Synchronization information may be sent. The at least a portion of the content item and the synchronization information may be sent by the first device to the second device. The synchronization information may allow the second device to at least partially synchronize output of the content item by the second device with output of the content item by the first device. The at least a portion of the content item and synchronization information may be sent based on the request for the content item. Synchronization information may comprise one or more of a byte range, a time stamp, a segment identifier, or a frame identifier indicative of a currently outputted portion of the content item. The synchronization information may comprise an indication of one or more of: a byte location in a data chunk of the content item, or a reference frame for decoding a frame at the byte location.

FIG. 6 depicts a computing device that may be used in various aspects, such as the servers, modules, and/or devices depicted in FIG. 1, FIG. 2A, FIG. 2B and FIG. 2C. With regard to the example architecture of FIG. 1, FIG. 2A, FIG. 2B and FIG. 2C, the server device (e.g., server device 102, server device 102, and/or server device 122), content server (e.g., content 112, content 132, and/or content 112), and network device (e.g., network device 104, network device 104, and/or network device 124) may each be implemented in an instance of a computing device 600 of FIG. 6. The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 3, FIG. 4, and FIG. 5.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random-access memory (RAM) 608 used as the main memory in the computing device 600. The chipset 606 may further provide an interface to a computer-readable storage medium, such as a read-only memory (ROM) 640 or non-volatile RAM (NVRAM) (not shown), for storing basic routines that may help to start up the computing device 600 and to transfer information between the various components and devices. ROM 640 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described in relation to FIG. 3, FIG. 4, and FIG. 5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

The term “or” when used with “one or more of” is used in its inclusive sense (and not in its exclusive sense) so that when used, for example, to connect a list of elements, the term “or” means one, some or all of the elements in the list. The term “or” when used with “at least one of” is used in its inclusive sense (and not in its exclusive sense) so that when used, for example, to connect a list of elements, the term “or” means one, some or all of the elements in the list. For example, the phrases “one or more of A, B, or C” includes any of the following: A, B, C, A and B, A and C, B and C, and A and B and C. Similarly, the phrase “one or more of A, B, and C” includes any of the following: A, B, C, A and B, A and C, B and C, and A and B and C. The phrase “at least one of A, B, or C” includes any of following: A, B, C, A and B, A and C, B and C, and A and B and C. Similarly, the phrase “at least one of A, B, and C” includes any of following: A, B, C, A and B, A and C, B and C, and A and B and C.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method comprising:
sending, by a first device and based on a request from a user to access a content item, a broadcast message associated with discovering nearby devices outputting the content item;
receiving, from a second device, a response message to the broadcast message; and
causing output, by the first device and based on accessing the content item from the second device, the content item, wherein the output of content item by the first device is at least partially synchronized with output of the content item by the second device based on synchronization information from the second device.

2. The method of claim 1, wherein the second device accesses the content item from a server device and stores the content item at least temporarily for output of the content item.

3. The method of claim 1, wherein the second device comprises one or more of a set-top box, a digital streaming device, or a user device.

4. The method of claim 1, wherein the broadcast message is broadcast to a plurality of devices in a neighborhood.

5. The method of claim 1, wherein the broadcast message is broadcast via a local area network located at a premises.

6. The method of claim 1, wherein synchronization information comprises one or more of a byte range, a time stamp, a segment identifier, or a frame identifier indicative of a currently outputted portion of the content item.

7. The method of claim 1, wherein the broadcast message comprises one or more of a transmission control protocol message, a layer two message, data link layer, or an ethernet message.

8. A method comprising:
causing, by a first device and based on a user request, output of a content item, wherein the content item is accessed from a server device and stored at least temporarily on the first device during output of the content item;
receiving, from a second device, a broadcast message associated with discovering nearby devices currently outputting the content item; and
sending, based on the broadcast message and to the second device, at least a portion of the content item and synchronization information that allows the second device to at least partially synchronize output of the content item by the second device with output of the content item by the first device.

9. The method of claim 8, wherein the first device progressively downloads, from the server device, segments of the content item as output of the content item via the second device progresses, and wherein the second device is configured to use the first device as an edge cache to access the segments currently downloaded to the second device.

10. The method of claim 8, wherein the first device comprises one or more of a set-top box, a digital streaming device, or a user device.

11. The method of claim 8, wherein the broadcast message is broadcast to a plurality of devices in a neighborhood.

12. The method of claim 8, wherein the broadcast message is broadcast via a local area network located at a premises.

13. The method of claim 8, wherein synchronization information comprises one or more of a byte range, a time stamp, a segment identifier, or a frame identifier indicative of a currently outputted portion of the content item.

14. The method of claim 8, wherein the broadcast message comprises one or more of a transmission control protocol message, a layer two message, data link layer, or an ethernet message.

15. A method comprising:
causing, by a first device based on a user request, output of a content item, wherein the content item is accessed from a server device and stored in at least partially on the first device during output of the content item;
sending, by the first device, a broadcast message associated with notifying nearby devices that the first device is storing the content item;
receiving, based on sending the broadcast message and from a second device, a request for the content item; and
sending, based on the request for the content item and to the second device, at least a portion of the content item and synchronization information that allows the second device to at least partially synchronize output of the content item by the second device with output of the content item by the first device.

16. The method of claim 15, wherein the first device progressively downloads, from the server device, segments of the content item as output of the content item via the second device progresses, and wherein the second device is configured to use the first device as an edge cache to access the segments currently downloaded to the second device.

17. The method of claim 15, wherein the first device comprises one or more of a set-top box, a digital streaming device, or a user device.

18. The method of claim 15, wherein the broadcast message is broadcast to a plurality of devices in a neighborhood.

19. The method of claim 15, wherein the broadcast message is broadcast via a local area network located at a premises.

20. The method of claim 15, wherein the broadcast message comprises one or more of a transmission control protocol message, a layer two message, data link layer, or an ethernet message.
